(19) United States
(12) Patent Application Publication
(10) Pub. No.: US 2025/0342814 A1
(43) Pub. Date: Nov. 6, 2025

(54) ACTIVE AERODYNAMIC NOISE CONTROL APPARATUS AND METHOD

(71) Applicant: HYUNDAI MOBIS CO., LTD., Seoul (KR)

(72) Inventor: Hyung Sub Lim, Yongin-si (KR)

(73) Assignee: HYUNDAI MOBIS CO., LTD., Seoul (KR)

(21) Appl. No.: 19/188,870

(22) Filed: Apr. 24, 2025

(30) Foreign Application Priority Data
May 3, 2024 (KR) 10-2024-0059179

(51) Int. Cl. G10K 11/178

(52) U.S. Cl. CPC G10K 11/17881; G10K 11/17823; G10K 2210/12821; G10K 2210/3018; G10K 2210/3055

(57) ABSTRACT

An active aerodynamic noise control apparatus includes a SoundCam installed inside a vehicle, an aerodynamic noise data measurement unit configured to measure aerodynamic noise data, an ultrasonic data measurement unit configured to measure primary ultrasonic data, an acoustic data measurement unit configured to measure primary acoustic data, a correlation coefficient calculation unit configured to calculate a correlation coefficient, an ultrasonic sensor location confirmation unit configured to confirm a secondary ultrasonic sensor location, an ultrasonic data collection unit configured to collect secondary ultrasonic data, an acoustic data collection unit configured to collect secondary acoustic data, an aerodynamic noise region determination unit configured to determine an aerodynamic noise region, an active noise control sound generation unit configured to generate an active noise control sound, and an active noise control sound output unit configured to output the generated active noise control sound.

This application claims the benefit of Korean Patent Application No. P2001-12345, filed on Sep. 17, 2001, which is hereby incorporated by reference as if fully set forth herein.

### BACKGROUND OF THE DISCLOSURE

### Field of the Disclosure

The present embodiments relate to active noise control, and more particularly, to a vehicle to which a method of outputting active noise control sound using a correlation coefficient with respect to aerodynamic noise is applied.

### Discussion of the Related Art

Vehicle manufacturers have made great efforts to reduce vehicle interior noise. As part of these efforts, in addition to passive methods such as adding or improving soundproofing or vibration damping materials, active noise control methods have been introduced to reduce noise by generating sound having an opposite phase to that of noise and superimposing the sound on the noise.

Recently, research has been conducted on a method of applying this active noise control method to blocking noise between passengers in addition to controlling noise coming from outside the vehicle, such as road noise.

Active noise control (ANC) systems adaptively cancel undesired noise in a listening environment, such as a vehicle cabin, by attenuating the undesired noise using feedforward and feedback structures. The ANC systems typically cancel or reduce undesired noise by generating canceling sound waves to destructively interfere with undesired audible noise.

Conventional ANC systems have problems in that the ANC systems do not have active noise control technology that takes into account an aerodynamic noise region, and repeat a process of randomly selecting an attachment location of a sensor for sensing the aerodynamic noise region and then performing testing, resulting in loss of cost and time.

### SUMMARY OF THE DISCLOSURE

Accordingly, the present disclosure is directed to an active aerodynamic noise control apparatus and method that substantially obviate one or more problems due to limitations and disadvantages of the related art.

In order to solve the problems described above, one embodiment of the present disclosure provides an active aerodynamic noise control apparatus that selects a vehicle aerodynamic noise region based on a correlation coefficient according to ultrasonic, acoustic, and SoundCam measurement data and outputs active noise control sound.

The problems to be solved in the present disclosure are not limited to the technical problems mentioned above, and other technical problems not mentioned herein may be clearly understood by a person having ordinary skill in the technical field to which the present disclosure pertains from the description below.

Additional advantages, objects, and features of the disclosure will be set forth in part in the description which follows and in part will become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

To achieve these objects and other advantages and in accordance with the purpose of the disclosure, as embodied and broadly described herein, an active aerodynamic noise control apparatus includes a SoundCam installed inside a vehicle, an aerodynamic noise data measurement unit configured to measure aerodynamic noise data based on SoundCam measurement data received from the installed SoundCam, an ultrasonic data measurement unit configured to measure primary ultrasonic data using a primary ultrasonic sensor previously installed inside the vehicle, an acoustic data measurement unit configured to measure primary acoustic data from an acoustic sensor previously installed inside the vehicle, a correlation coefficient calculation unit configured to calculate a correlation coefficient based on the primary ultrasonic data and the primary acoustic data, an ultrasonic sensor location confirmation unit configured to confirm a secondary ultrasonic sensor location based on the correlation coefficient, an ultrasonic data collection unit configured to collect secondary ultrasonic data from the secondary ultrasonic sensor location confirmed by the ultrasonic sensor location confirmation unit, an acoustic data collection unit configured to collect secondary acoustic data from the acoustic sensor based on driving of the vehicle, an aerodynamic noise region determination unit configured to determine an aerodynamic noise region based on the secondary ultrasonic data, the secondary acoustic data, and the calculated correlation coefficient, an active noise control sound generation unit configured to generate an active noise control sound based on the determined aerodynamic noise region, and an active noise control sound output unit configured to output the generated active noise control sound.

The aerodynamic noise data measurement unit may store, in a database, aerodynamic noise data measured while changing a vehicle/speed/weather-specific adjustment factor.

The correlation coefficient calculation unit may be configured to calculate a correlation coefficient between the SoundCam measurement data and the primary ultrasonic data, calculate a correlation coefficient between the primary ultrasonic data and the primary acoustic data, and calculate a correlation coefficient between the SoundCam measurement data and the primary acoustic data.

The correlation coefficient calculation unit may derive a transfer function and coherence among the SoundCam measurement data, the primary ultrasonic data, and the primary acoustic data.

The aerodynamic noise region determination unit may be configured to measure vehicle noise generated in a dynamo environment, measure vehicle noise including aerodynamic noise generated by vehicle driving, and determine an aerodynamic noise region based on the vehicle noise generated in the dynamo environment, the vehicle noise including the aerodynamic noise, the secondary ultrasonic data, the secondary acoustic data, and the calculated correlation coefficients.

It is to be understood that both the foregoing general description and the following detailed description of the present disclosure are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is an overall block diagram of an autonomous driving control system to which an autonomous driving device according to any one of the embodiments of the present disclosure may be applied;

FIG. 2 is an example diagram illustrating an example in which the autonomous driving device according to any one of the embodiments of the present disclosure is applied to an autonomous vehicle;

FIG. 3 is a diagram for describing a configuration of an active aerodynamic noise control apparatus according to an embodiment of the present disclosure; and

FIG. 4 is a flowchart for describing an active aerodynamic noise control method according to an embodiment of the present disclosure.

### DETAILED DESCRIPTION OF THE DISCLOSURE

Hereinafter, embodiments of the present disclosure will be described in detail with reference to the attached drawings so that a person having ordinary skill in the art to which the present disclosure pertains may easily practice the present disclosure. However, the present disclosure may be implemented in various different forms and is not limited to the embodiments described herein. In addition, in order to clearly describe the present disclosure in the drawings, parts not related to the description have been omitted, and similar parts have been given similar drawing reference numerals throughout the specification.

Throughout the specification, whenever a part is described to “include” a component, this means that other components may be further included rather than being excluded, unless stated otherwise.

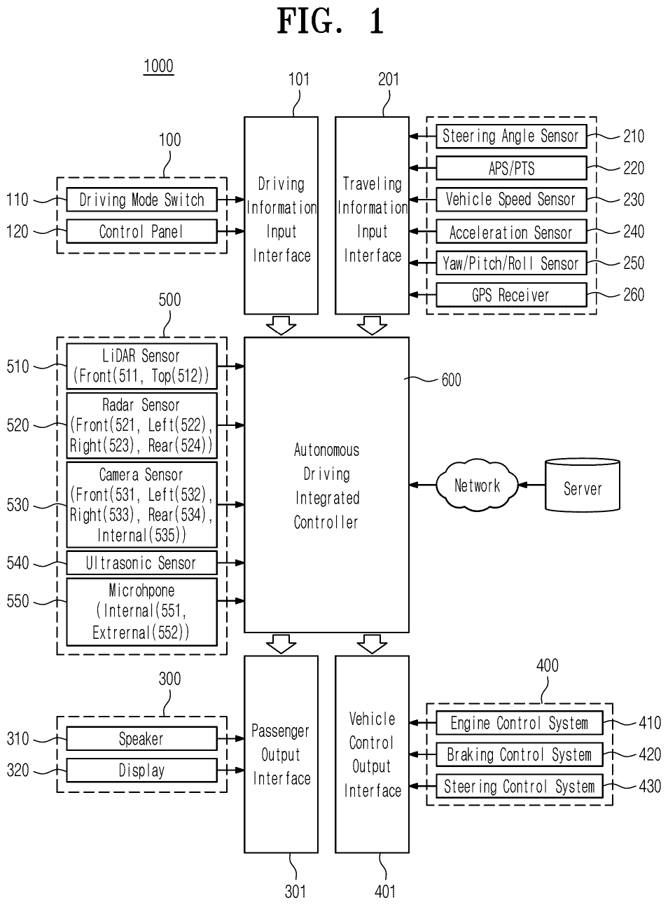

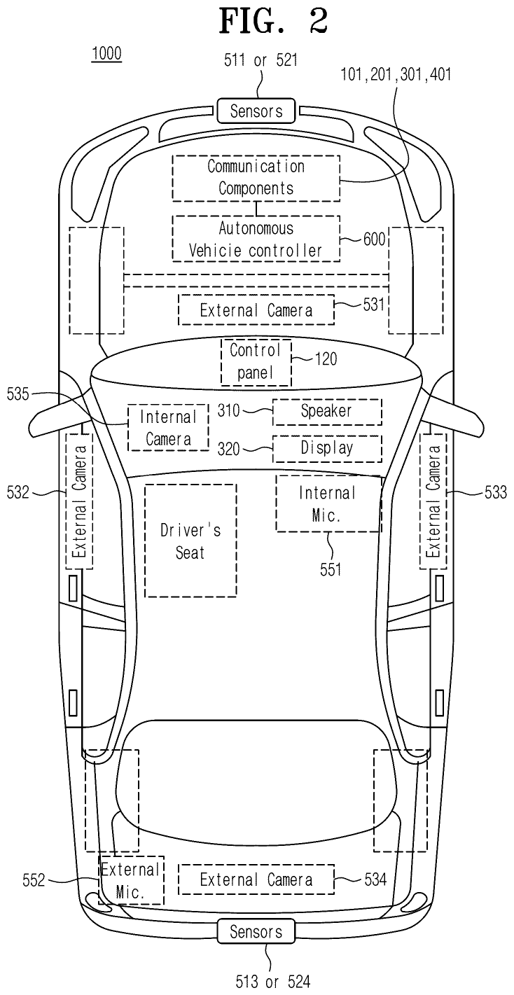

FIG. 1 is an overall block diagram of an autonomous driving control system to which an autonomous driving apparatus according to any one of embodiments of the present disclosure is applicable. FIG. 2 is a diagram illustrating an example in which an autonomous driving apparatus according to any one of embodiments of the present disclosure is applied to a vehicle.

First, a structure and function of an autonomous driving control system (e.g., an autonomous driving vehicle) to which an autonomous driving apparatus according to the present embodiments is applicable will be described with reference to FIGS. 1 and 2.

As illustrated in FIG. 1, an autonomous driving vehicle 1000 may be implemented based on an autonomous driving integrated controller 600 that transmits and receives data necessary for autonomous driving control of a vehicle through a driving information input interface 101, a traveling information input interface 201, an occupant output interface 301, and a vehicle control output interface 401. However, the autonomous driving integrated controller 600 may also be referred to herein as a controller, a processor, or, simply, a controller.

The autonomous driving integrated controller 600 may obtain, through the driving information input interface 101, driving information based on manipulation of an occupant for a user input unit 100 in an autonomous driving mode or manual driving mode of a vehicle. As illustrated in FIG. 1, the user input unit 100 may include a driving mode switch 110 and a control panel 120 (e.g., a navigation terminal mounted on the vehicle or a smartphone or tablet computer owned by the occupant). Accordingly, driving information may include driving mode information and navigation information of a vehicle.

For example, a driving mode (i.e., an autonomous driving mode/manual driving mode or a sports mode/eco mode/safety mode/normal mode) of the vehicle determined by manipulation of the occupant for the driving mode switch 110 may be transmitted to the autonomous driving integrated controller 600 through the driving information input interface 101 as the driving information.

Furthermore, navigation information, such as the destination of the occupant input through the control panel 120 and a path up to the destination (e.g., the shortest path or preference path, selected by the occupant, among candidate paths up to the destination), may be transmitted to the autonomous driving integrated controller 600 through the driving information input interface 101 as the driving information.

The control panel 120 may be implemented as a touchscreen panel that provides a user interface (UI) through which the occupant inputs or modifies information for autonomous driving control of the vehicle. In this case, the driving mode switch 110 may be implemented as touch buttons on the control panel 120.

In addition, the autonomous driving integrated controller 600 may obtain traveling information indicative of a driving state of the vehicle through the traveling information input interface 201. The traveling information may include a steering angle formed when the occupant manipulates a steering wheel, an accelerator pedal stroke or brake pedal stroke formed when the occupant depresses an accelerator pedal or brake pedal, and various types of information indicative of driving states and behaviors of the vehicle, such as a vehicle speed, acceleration, a yaw, a pitch, and a roll formed in the vehicle. The traveling information may be detected by a traveling information detection unit 200, including a steering angle sensor 210, an accelerator position sensor (APS)/pedal travel sensor (PTS) 220, a vehicle speed sensor 230, an acceleration sensor 240, and a yaw/pitch/roll sensor 250, as illustrated in FIG. 1.

Furthermore, the traveling information of the vehicle may include location information of the vehicle. The location information of the vehicle may be obtained through a global positioning system (GPS) receiver 260 applied to the vehicle. Such traveling information may be transmitted to the autonomous driving integrated controller 600 through the traveling information input interface 201 and may be used to control the driving of the vehicle in the autonomous driving mode or manual driving mode of the vehicle.

The autonomous driving integrated controller 600 may transmit driving state information provided to the occupant to an output unit 300 through the occupant output interface 301 in the autonomous driving mode or manual driving mode of the vehicle. That is, the autonomous driving integrated controller 600 transmits the driving state information of the vehicle to the output unit 300 so that the occupant may check the autonomous driving state or manual driving state of the vehicle based on the driving state information output through the output unit 300. The driving state information may include various types of information indicative of driving states of the vehicle, such as a current driving mode, transmission range, and speed of the vehicle.

If it is determined that it is necessary to warn a driver in the autonomous driving mode or manual driving mode of the vehicle along with the above driving state information, the autonomous driving integrated controller 600 transmits warning information to the output unit 300 through the occupant output interface 301 so that the output unit 300 may output a warning to the driver. In order to output such driving state information and warning information acoustically and visually, the output unit 300 may include a speaker 310 and a display 320 as illustrated in FIG. 1. In this case, the display 320 may be implemented as the same device as the control panel 120 or may be implemented as an independent device separated from the control panel 120.

Furthermore, the autonomous driving integrated controller 600 may transmit control information for driving control of the vehicle to a lower control system 400, applied to the vehicle, through the vehicle control output interface 401 in the autonomous driving mode or manual driving mode of the vehicle. As illustrated in FIG. 1, the lower control system 400 for driving control of the vehicle may include an engine control system 410, a braking control system 420, and a steering control system 430. The autonomous driving integrated controller 600 may transmit engine control information, braking control information, and steering control information, as the control information, to the respective lower control systems 410, 420, and 430 through the vehicle control output interface 401. Accordingly, the engine control system 410 may control the speed and acceleration of the vehicle by increasing or decreasing fuel supplied to an engine. The braking control system 420 may control the braking of the vehicle by controlling braking power of the vehicle. The steering control system 430 may control the steering of the vehicle through a steering device (e.g., motor driven power steering (M DPS) system) applied to the vehicle.

As described above, the autonomous driving integrated controller 600 according to the present embodiment may obtain the driving information based on manipulation of the driver and the traveling information indicative of the driving state of the vehicle through the driving information input interface 101 and the traveling information input interface 201, respectively, and transmit the driving state information and the warning information, generated based on an autonomous driving algorithm, to the output unit 300 through the occupant output interface 301. In addition, the autonomous driving integrated controller 600 may transmit the control information generated based on the autonomous driving algorithm to the lower control system 400 through the vehicle control output interface 401 so that driving control of the vehicle is performed.

In order to guarantee stable autonomous driving of the vehicle, it is necessary to continuously monitor the driving state of the vehicle by accurately measuring a driving environment of the vehicle and to control driving based on the measured driving environment. To this end, as illustrated in FIG. 1, the autonomous driving apparatus according to the present embodiment may include a sensor unit 500 for detecting a nearby object of the vehicle, such as a nearby vehicle, pedestrian, road, or fixed facility (e.g., a signal light, a signpost, a traffic sign, or a construction fence).

The sensor unit 500 may include one or more of a LiDAR sensor 510, a radar sensor 520, or a camera sensor 530, in order to detect a nearby object outside the vehicle, as illustrated in FIG. 1.

The LiDAR sensor 510 may transmit a laser signal to the periphery of the vehicle and detect a nearby object outside the vehicle by receiving a signal reflected and returning from a corresponding object. The LiDAR sensor 510 may detect a nearby object located within the ranges of a preset distance, a preset vertical field of view, and a preset horizontal field of view, which are predefined depending on specifications thereof. The LiDAR sensor 510 may include a front LiDAR sensor 511, a top LiDAR sensor 512, and a rear LiDAR sensor 513 installed at the front, top, and rear of the vehicle, respectively, but the installation location of each LiDAR sensor and the number of LiDAR sensors installed are not limited to a specific embodiment. A threshold for determining the validity of a laser signal reflected and returning from a corresponding object may be previously stored in a memory (not illustrated) of the autonomous driving integrated controller 600. The autonomous driving integrated controller 600 may determine a location (including a distance to a corresponding object), speed, and moving direction of the corresponding object using a method of measuring time taken for a laser signal, transmitted through the LiDAR sensor 510, to be reflected and returning from the corresponding object.

The radar sensor 520 may radiate electromagnetic waves around the vehicle and detect a nearby object outside the vehicle by receiving a signal reflected and returning from a corresponding object. The radar sensor 520 may detect a nearby object within the ranges of a preset distance, a preset vertical field of view, and a preset horizontal field of view, which are predefined depending on specifications thereof. The radar sensor 520 may include a front radar sensor 521, a left radar sensor 522, a right radar sensor 523, and a rear radar sensor 524 installed at the front, left, right, and rear of the vehicle, respectively, but the installation location of each radar sensor and the number of radar sensors installed are not limited to a specific embodiment. The autonomous driving integrated controller 600 may determine a location (including a distance to a corresponding object), speed, and moving direction of the corresponding object using a method of analyzing power of electromagnetic waves transmitted and received through the radar sensor 520.

The camera sensor 530 may detect a nearby object outside the vehicle by photographing the periphery of the vehicle and detect a nearby object within the ranges of a preset distance, a preset vertical field of view, and a preset horizontal field of view, which are predefined depending on specifications thereof.

The camera sensor 530 may include a front camera sensor 531, a left camera sensor 532, a right camera sensor 533, and a rear camera sensor 534 installed at the front, left, right, and rear of the vehicle, respectively, but the installation location of each camera sensor and the number of camera sensors installed are not limited to a specific embodiment. The autonomous driving integrated controller 600 may determine a location (including a distance to a corresponding object), speed, and moving direction of the corresponding object by applying predefined image processing to an image captured by the camera sensor 530.

In addition, an internal camera sensor 535 for capturing the inside of the vehicle may be mounted at a predetermined location (e.g., rear view mirror) within the vehicle. The autonomous driving integrated controller 600 may monitor a behavior and state of the occupant based on an image captured by the internal camera sensor 535 and output guidance or a warning to the occupant through the output unit 300.

As illustrated in FIG. 1, the sensor unit 500 may further include an ultrasonic sensor 540 in addition to the LiDAR sensor 510, the radar sensor 520, and the camera sensor 530 and further adopt various types of sensors for detecting a nearby object of the vehicle along with the sensors.

FIG. 2 illustrates an example in which, in order to aid in understanding the present embodiment, the front LiDAR sensor 511 or the front radar sensor 521 is installed at the front of the vehicle, the rear LiDAR sensor 513 or the rear radar sensor 524 is installed at the rear of the vehicle, and the front camera sensor 531, the left camera sensor 532, the right camera sensor 533, and the rear camera sensor 534 are installed at the front, left, right, and rear of the vehicle, respectively. However, as described above, the installation location of each sensor and the number of sensors installed are not limited to a specific embodiment.

Furthermore, in order to determine a state of the occupant within the vehicle, the sensor unit 500 may further include a bio sensor for detecting bio signals (e.g., heart rate, electrocardiogram, respiration, blood pressure, body temperature, electroencephalogram, photoplethysmography (or pulse wave), and blood sugar) of the occupant. The bio sensor may include a heart rate sensor, an electrocardiogram sensor, a respiration sensor, a blood pressure sensor, a body temperature sensor, an electroencephalogram sensor, a photoplethysmography sensor, and a blood sugar sensor.

Finally, the sensor unit 500 additionally includes a microphone 550 having an internal microphone 551 and an external microphone 552 used for different purposes.

The internal microphone 551 may be used, for example, to analyze the voice of the occupant in the autonomous driving vehicle 1000 based on AI or to immediately respond to a direct voice command of the occupant.

In contrast, the external microphone 552 may be used, for example, to appropriately respond to safe driving by analyzing various sounds generated from the outside of the autonomous driving vehicle 1000 using various analysis tools such as deep learning.

For reference, the symbols illustrated in FIG. 2 may perform the same or similar functions as those illustrated in FIG. 1. FIG. 2 illustrates in more detail a relative positional relationship of each component (based on the interior of the autonomous driving vehicle 1000) as compared with FIG. 1.

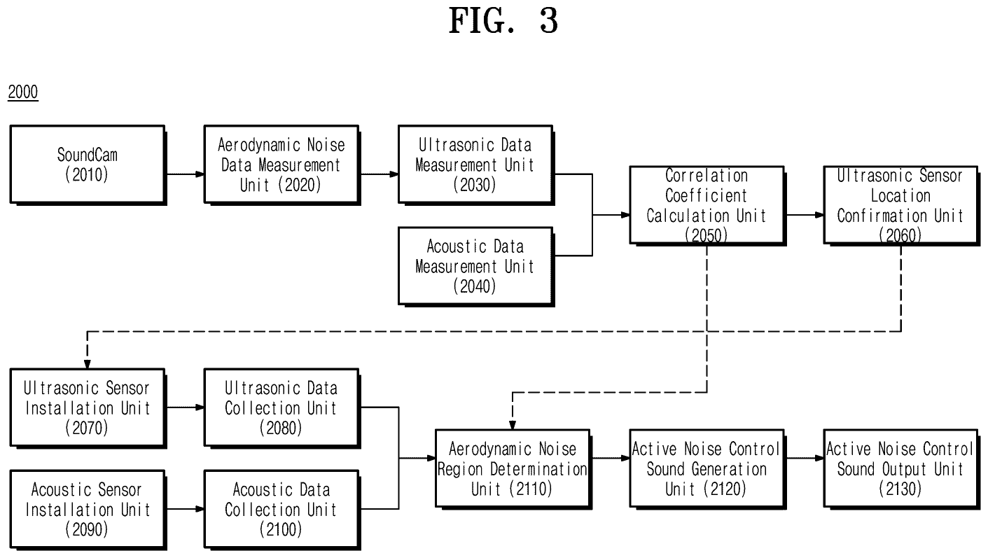

FIG. 3 is a diagram for describing a configuration of an active aerodynamic noise control apparatus according to an embodiment of the present disclosure.

Referring to FIG. 3, the active aerodynamic noise control apparatus 2000 may include a SoundCam 2010, an aerodynamic noise data measurement unit 2020, an ultrasonic data measurement unit 2030, an acoustic data measurement unit 2040, a correlation coefficient calculation unit 2050, an ultrasonic sensor location confirmation unit 2060, an ultrasonic sensor installation unit 2070, an ultrasonic data collection unit 2080, an acoustic sensor installation unit 2090, an acoustic data collection unit 2100, an aerodynamic noise region determination unit 2110, an active noise control sound generation unit 2120, and an active noise control sound output unit 2130. According to an exemplary embodiment of the present disclosure, the active aerodynamic noise control apparatus 2000 may include a processor (e.g., computer, microprocessor, CPU, ASIC, circuitry, logic circuits, etc.) and an associated non-transitory memory storing software instructions which, when executed by the processor, provides the aerodynamic noise data measurement unit 2020, the ultrasonic data measurement unit 2030, the acoustic data measurement unit 2040, the correlation coefficient calculation unit 2050, the ultrasonic sensor location confirmation unit 2060, the ultrasonic sensor installation unit 2070, an ultrasonic data collection unit 2080, the acoustic sensor installation unit 2090, the acoustic data collection unit 2100, the aerodynamic noise region determination unit 2110, the active noise control sound generation unit 2120, and the active noise control sound output unit 2130. Herein, the memory and the processor may be implemented as separate semiconductor circuits. Alternatively, the memory and the processor may be implemented as a single integrated semiconductor circuit. The processor may embody one or more processor(s).

The SoundCam 2010 may be a device capable of visualizing anything generated as air, gas leak, and electrical noise in an audible range and a high frequency range. For example, the SoundCam 2010 may include an ultrasonic imager and an acoustic imager.

For example, aerodynamic noise may be noise in a resonant frequency range of 500 to 10,000 Hz in a noise range in the audible frequency range.

SoundCam measurement data measured by the SoundCam 2010 may include visualized noise.

The SoundCam 2010 may be installed inside a vehicle to collect data for measuring aerodynamic noise.

For example, the SoundCam 2010 may measure aerodynamic noise generated by a windshield of the vehicle.

The aerodynamic noise data measurement unit 2020 may measure aerodynamic noise data using the installed SoundCam 2010. Representative noise sources of the vehicle include road noise, aerodynamic noise, and engine noise. When the vehicle is driven at low speed, road noise is prominent, but as the speed increases, aerodynamic noise becomes the primary noise source. In other words, a background noise level of aerodynamic noise varies depending on the vehicle speed.

The aerodynamic noise data measurement unit 2020 may create a database (DB) by measuring vehicle/speed/weather-specific data while changing an adjustment factor. For example, the weather-specific data may include wind direction data and wind speed data.

The aerodynamic noise data measurement unit 2020 may generate aerodynamic noise data that varies depending on the wind direction to provide active noise control sound according to vehicle speed.

For example, the aerodynamic noise data measurement unit 2020 may generate aerodynamic noise data based on wind direction data that varies depending on whether wind blows against the vehicle.

The ultrasonic data measurement unit 2030 may measure ultrasonic waves through a temporarily mounted ultrasonic sensor. The ultrasonic data measurement unit 2030 may store the measured ultrasonic waves as sensor values.

The ultrasonic data measurement unit 2030 may acquire ultrasonic sensor values measured by the ultrasonic sensor attached to a location where aerodynamic noise is measured as data based on a database (DB) created by the aerodynamic noise data measurement unit 2020.

The acoustic data measurement unit 2040 may measure acoustic data by receiving noise through a microphone installed in the vehicle.

The correlation coefficient calculation unit 2050 may calculate a correlation coefficient of a plurality of data pairs based on data measured by the ultrasonic data measurement unit 2030 and the acoustic data measurement unit 2040.

The correlation coefficient calculation unit 2050 may calculate a correlation coefficient between SoundCam measurement data and ultrasonic sensor data.

The correlation coefficient calculation unit 2050 may calculate a correlation coefficient between ultrasonic sensor data and acoustic data.

The correlation coefficient calculation unit 2050 may calculate a correlation coefficient between SoundCam measurement data and acoustic data.

The correlation coefficient calculation unit 2050 may derive a transfer function and coherence among the SoundCam, ultrasonic sensor, and acoustic data.

The correlation coefficient calculation unit 2050 may derive a cross-correlation coefficient and a normalized cross-correlation coefficient through the following Equation 1.

$$Correlation coefficient ( X , Y ) = \frac{1}{n} {{\sum }^{n}}_{i = 1} \frac{( {x}_{i} - \overline{x} ) ( {y}_{i} - \overline{y} )}{{σ}_{x} {σ}_{y}} \qquad [ Equation 1 ]$$

$$NCC ( f , g ) = \frac{1}{n} {{\sum }^{n}}_{i = 1} \frac{f ( {x}_{i} ) g ( {x}_{i} )}{{σ}_{f} {σ}_{g}} or \frac{1}{n} {{\sum }^{n}}_{i = 1} \frac{( f ( {x}_{i} - \overline{f} ) ( g ( {x}_{i} - \overline{g} )}{{σ}_{f} {σ}_{g}}$$

In this instance, x̅ denotes an average of X, n denotes number of pieces of data, xᵢ denotes an X attribute value of an ith piece of observation data, σₓ denotes a standard deviation of X, and f(x) and g(x) may be signal values at x.

The ultrasonic sensor location confirmation unit 2060 may confirm an ultrasonic sensor location based on a region having a best correlation based on correlation data received from the correlation coefficient calculation unit 2050.

The ultrasonic sensor installation unit 2070 may install a secondary ultrasonic sensor in a region previously confirmed by the ultrasonic sensor location confirmation unit 2060.

The ultrasonic data collection unit 2080 may collect secondary ultrasonic data from the secondary ultrasonic sensor installed using the ultrasonic sensor installation unit 2080.

The acoustic sensor installation unit 2090 may install an acoustic sensor in a vehicle desiring to output actual active noise control sound.

The acoustic data collection unit 2100 may collect secondary acoustic data from the secondary acoustic sensor installed using the acoustic sensor installation unit 2090.

The aerodynamic noise region determination unit 2110 may determine an aerodynamic noise region based on data measured by the ultrasonic data collection unit 2090 and the acoustic data collection unit 2100.

The aerodynamic noise region determination unit 2110 may determine aerodynamic noise from the measured ultrasonic data and acoustic data using the pre-calculated transfer function and correlation coefficient.

The aerodynamic noise region determination unit 2110 may measure and compare vehicle basic noise in a default state and vehicle noise in an aerodynamic noise generation state while the vehicle is driven. In this instance, the vehicle basic noise may be noise measured in a dynamo environment. For example, the dynamo environment may be an environment in which power of a rotating body such as a motor or an engine of the vehicle is measured.

For example, the aerodynamic noise region determination unit 2110 may measure vehicle noise based on a difference between the vehicle noise in the aerodynamic noise generation state and the vehicle basic noise, data from an external environment such as an ultrasonic region due to ultrasonic waves inside the vehicle, etc.

Meanwhile, the aerodynamic noise region determination unit 2110 may analyze intensity, a phase, and a frequency of the acoustic data received from the acoustic data collection unit 2100 and the ultrasonic data received from the ultrasonic data collection unit 2090.

The aerodynamic noise region determination unit 2110 may recognize a situation inside the vehicle including a location where aerodynamic noise is generated based on a frequency analysis result.

For example, the aerodynamic noise region determination unit 2110 may identify a source of aerodynamic noise through change in a phase or frequency difference of a synthetic wave received through at least one of visualized noise, acoustic data, or ultrasonic data collected for aerodynamic noise generated inside the vehicle. That is, when aerodynamic noise is generated from a windshield inside the vehicle, a source of aerodynamic noise may be determined to be the windshield by comparison with a pre-stored database DB.

For example, the aerodynamic noise region determination unit 2110 may determine that there is aerodynamic noise from the windshield when intensity of the visualized noise, acoustic data, and ultrasonic data is relatively large. The aerodynamic noise region determination unit 2110 may determine that there is no aerodynamic noise from the windshield when the intensity of the visualized noise, acoustic data, and ultrasonic data is relatively small.

For example, the aerodynamic noise region determination unit 2110 may recognize the location of the aerodynamic noise source by utilizing a characteristic that, in the case of aerodynamic noise from the windshield, when the source of the aerodynamic noise is a location near the acoustic sensor or ultrasonic sensor depending on the direction of travel of the vehicle, a low frequency lower than frequencies of the acoustic signal received from the acoustic data collection unit 2100 and the ultrasonic signal received from the ultrasonic sensor installation unit 2010 is observed, and when the source of the aerodynamic noise is a location far from the windshield, a high frequency higher than the frequencies of the acoustic signal received from the acoustic data collection unit 2100 and the ultrasonic signal received from the ultrasonic sensor installation unit 2010 is generated.

The active noise control sound generation unit 2120 may generate active noise control sound in a frequency range of an aerodynamic noise band determined by the aerodynamic noise region determination unit 2110.

The active noise control sound generation unit 2120 may generate active noise control sound in response to a driving environment of the vehicle.

For example, the active noise control sound generation unit 2120 may generate active noise control sound corresponding to driving on a general road when the vehicle is driving on the general road.

For example, the active noise control sound generation unit 2120 may distinguish aerodynamic noise among noises inside the vehicle and adjust output of active control sound according to the aerodynamic noise, so that the active control sound transmitting the same feeling may be delivered to a passenger regardless of a road condition or a wind direction, which has an advantage of improving auditory satisfaction.

The active noise control sound output unit 2130 may output the active noise control sound generated by the active noise control sound generation unit 2120.

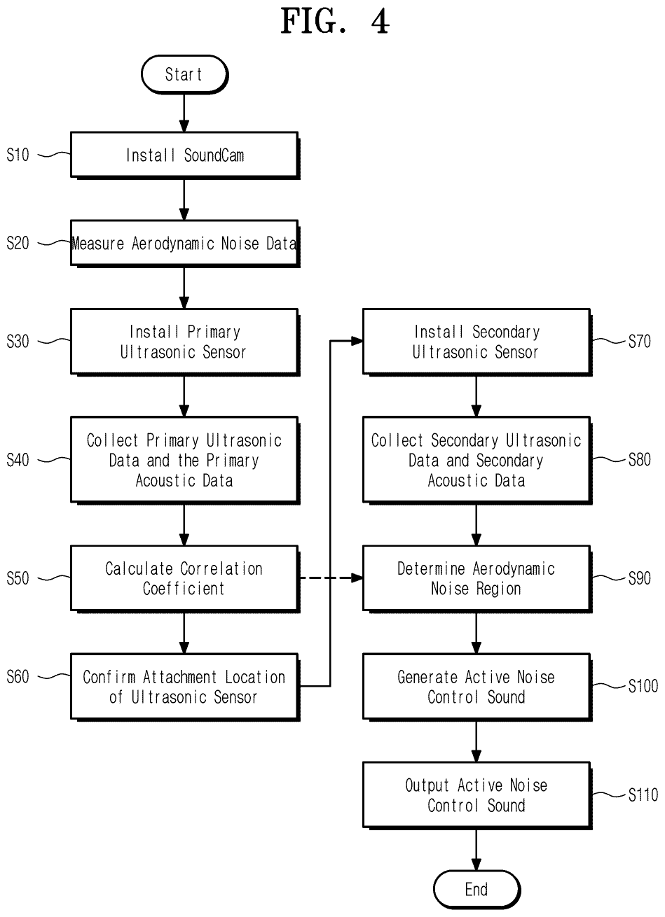

FIG. 4 is a flowchart for describing an active aerodynamic noise control method according to an embodiment of the present disclosure.

Referring to FIG. 4, the active aerodynamic noise control apparatus 2000 may measure aerodynamic noise data by installing a SoundCam (S10 and S20). The active aerodynamic noise control apparatus 2000 may measure aerodynamic noise data based on SoundCam measurement data received from the installed SoundCam. Aerodynamic noise data in an audible range and a high frequency range generated in a windshield area of the vehicle, etc. may be measured as the aerodynamic noise data by a SoundCam installed inside the vehicle. For example, the active aerodynamic noise control apparatus 2000 may store the measured aerodynamic noise data in a database while changing a vehicle/speed/weather-specific adjustment factor.

After step S10, the active aerodynamic noise control apparatus 2000 may install a primary ultrasonic sensor (S20).

After step S20, the active aerodynamic noise control apparatus 2000 may measure a sensor value through the installed primary ultrasonic sensor and a noise sensor (S30). Thereafter, the active aerodynamic noise control apparatus 2000 may measure primary ultrasonic data using the primary ultrasonic sensor installed in the vehicle, and measure primary acoustic data from an acoustic sensor previously installed in the vehicle.

Meanwhile, the active aerodynamic noise control apparatus 2000 may collect coherence for each vehicle type (S40). To this end, the active aerodynamic noise control apparatus 2000 may calculate a correlation coefficient based on the primary ultrasonic data and the primary acoustic data.

After step S40, the active aerodynamic noise control apparatus 2000 may determine performance of active noise control for each vehicle type based on the collected coherence and store the performance in the DB (550).

The active aerodynamic noise control apparatus 2000 may examine a correlation coefficient based on the measured sensor value and the stored coherence (S60).

For example, the active aerodynamic noise control apparatus 2000 may calculate a correlation coefficient between the SoundCam measurement data and the primary ultrasonic data, calculate a correlation coefficient between the primary ultrasonic data and the primary acoustic data, and calculate a correlation coefficient between the SoundCam measurement data and the primary acoustic data. In addition, the active aerodynamic noise control apparatus 2000 may derive a transfer function and coherence among the SoundCam measurement data, the primary ultrasonic data, and the primary acoustic data.

After step S60, the active aerodynamic noise control apparatus 2000 may be installed by selecting a location of the secondary ultrasonic sensor (S70).

After step S70, the active aerodynamic noise control apparatus 2000 may collect secondary ultrasonic data from the secondary ultrasonic sensor and secondary acoustic data from the acoustic sensor (S80).

After step S80, the active aerodynamic noise control apparatus 2000 may determine an aerodynamic noise region based on the secondary ultrasonic data, the secondary acoustic data, and the calculated correlation coefficients (S90). To this end, the active aerodynamic noise control apparatus 2000 may measure vehicle noise generated in a dynamo environment, measure vehicle noise including aerodynamic noise generated according to vehicle driving, and determine an aerodynamic noise region based on the vehicle noise generated in the dynamo environment, the vehicle noise including the aerodynamic noise, the secondary ultrasonic data, the secondary acoustic data, and the calculated correlation coefficients.

After step S90, the active aerodynamic noise control apparatus 2000 may generate active noise control sound based on the determined aerodynamic noise region (S100).

After step S100, the active aerodynamic noise control apparatus 2000 may output the generated active noise control sound (S110).

According to one of the embodiments of the present disclosure, there is an effect of selecting an optimal sensor attachment location for improving performance of active noise control considering an aerodynamic noise region, and performing active noise control considering aerodynamic noise, thereby improving user satisfaction.

Effects obtainable from the present disclosure are not limited to the effects mentioned above, and other effects not mentioned herein may be clearly understood by a person having ordinary skill in the art to which the present disclosure pertains from the above description.

That is, the technical idea of the present disclosure may be applied to the entire autonomous vehicle or may be applied to only some components inside the autonomous vehicle. The scope of the rights of the present disclosure should be determined according to the matters described in the patent claims.

As another aspect of the present disclosure, the operation of the proposal or proposal described above may be provided as code that may be implemented, performed or executed by a “computer” (a comprehensive concept including a system on chip (SoC) or a microprocessor, etc.), an application storing or including the code, a computer-readable storage medium, a computer program product, etc., which falls within the scope of the present disclosure.

The detailed description of the preferred embodiments of the present disclosure disclosed above has been provided to enable those skilled in the art to implement and practice the present disclosure. Even though a description has been given above with reference to the preferred embodiments of the present disclosure, it should be understood that those skilled in the art will understand that the present disclosure may be variously modified and changed without departing from the scope of the present disclosure. For example, those skilled in the art may utilize each of the configurations described in the above-described embodiments by combining the configurations.

Accordingly, the present disclosure is not intended to be limited to the embodiments shown herein but is to be accorded the widest scope consistent with the principles and novel features disclosed herein.

What is claimed is:

1. A n active aerodynamic noise control apparatus, the apparatus comprising:
a SoundCam installed inside a vehicle that measure SoundCam measurement data;
an aerodynamic noise data measurement unit configured to measure aerodynamic noise data based on the SoundCam measurement data received from the installed SoundCam;
an ultrasonic data measurement unit configured to measure primary ultrasonic data using a primary ultrasonic sensor previously installed inside the vehicle;
an acoustic data measurement unit configured to measure primary acoustic data from an acoustic sensor previously installed inside the vehicle;
a correlation coefficient calculation unit configured to calculate a correlation coefficient based on the primary ultrasonic data and the primary acoustic data;
an ultrasonic sensor location confirmation unit configured to confirm a secondary ultrasonic sensor location based on the correlation coefficient;
an ultrasonic data collection unit configured to collect secondary ultrasonic data from the secondary ultrasonic sensor location confirmed by the ultrasonic sensor location confirmation unit;
an acoustic data collection unit configured to collect secondary acoustic data from the acoustic sensor based on driving of the vehicle;
an aerodynamic noise region determination unit configured to determine an aerodynamic noise region based on the secondary ultrasonic data, the secondary acoustic data, and the calculated correlation coefficient;
an active noise control sound generation unit configured to generate an active noise control sound based on the determined aerodynamic noise region; and
an active noise control sound output unit configured to output the generated active noise control sound.

2. The active aerodynamic noise control apparatus according to claim 1, wherein the aerodynamic noise data measurement unit stores, in a database, aerodynamic noise data measured while changing a vehicle/speed/weather-specific adjustment factor.

3. The active aerodynamic noise control apparatus according to claim 1, wherein the correlation coefficient calculation unit is configured to:
calculate a correlation coefficient between the SoundCam measurement data and the primary ultrasonic data,
calculate a correlation coefficient between the primary ultrasonic data and the primary acoustic data, and
calculate a correlation coefficient between the SoundCam measurement data and the primary acoustic data.

4. The active aerodynamic noise control apparatus according to claim 3, wherein the correlation coefficient calculation unit derives a transfer function and coherence among the SoundCam measurement data, the primary ultrasonic data, and the primary acoustic data.

5. The active aerodynamic noise control apparatus according to claim 4, wherein the aerodynamic noise region determination unit is configured to:
measure vehicle noise generated in a dynamo environment,
measure vehicle noise including aerodynamic noise generated by vehicle driving, and
determine an aerodynamic noise region based on the vehicle noise generated in the dynamo environment, the vehicle noise including the aerodynamic noise, the secondary ultrasonic data, the secondary acoustic data, and the calculated correlation coefficients.

6. A n active aerodynamic noise control method, the method comprising:
installing a SoundCam inside a vehicle that measures SoundCam measurement data;
measuring aerodynamic noise data based on the SoundCam measurement data received from the installed SoundCam;
measuring primary ultrasonic data using a primary ultrasonic sensor previously installed inside the vehicle;
measuring primary acoustic data from an acoustic sensor previously installed inside the vehicle;
calculating a correlation coefficient based on the primary ultrasonic data and the primary acoustic data;
confirming a secondary ultrasonic sensor location based on the correlation coefficient;
collecting secondary ultrasonic data from the confirmed secondary ultrasonic sensor location;
collecting secondary acoustic data from the acoustic sensor based on driving of the vehicle;
determining an aerodynamic noise region based on the secondary ultrasonic data, the secondary acoustic data, and the calculated correlation coefficient;
generating an active noise control sound based on the determined aerodynamic noise region; and
outputting the generated active noise control sound.

7. The active aerodynamic noise control method according to claim 6, wherein the measuring aerodynamic noise data comprises storing, in a database, aerodynamic noise data measured while changing a vehicle/speed/weather-specific adjustment factor.

8. The active aerodynamic noise control method according to claim 6, wherein the calculating a correlation coefficient comprises:
calculating a correlation coefficient between the SoundCam measurement data and the primary ultrasonic data,
calculating a correlation coefficient between the primary ultrasonic data and the primary acoustic data, and
calculating a correlation coefficient between the SoundCam measurement data and the primary acoustic data.

9. The active aerodynamic noise control method according to claim 8, further comprising deriving a transfer function and coherence among the SoundCam measurement data, the primary ultrasonic data, and the primary acoustic data.

10. The active aerodynamic noise control method according to claim 9, wherein the determining an aerodynamic noise region comprises:
measuring vehicle noise generated in a dynamo environment,
measuring vehicle noise including aerodynamic noise generated by vehicle driving, and
determining an aerodynamic noise region based on the vehicle noise generated in the dynamo environment, the vehicle noise including the aerodynamic noise, the secondary ultrasonic data, the secondary acoustic data, and the calculated correlation coefficients.
